(19) United States
(12) Patent Application Publication
(10) Pub. No.: US 2026/0264273 A1
(43) Pub. Date: Sep. 10, 2026

(54) ROBOT ARM, ROBOT COMPRISING ROBOT ARM AND CONTROL METHOD THEREFOR

(71) Applicant: SAMSUNG ELECTRONICS CO., LTD., Suwon-si (KR)

(72) Inventor: Kuemjong BAE, Suwon-si (KR)

(73) Assignee: SAMSUNG ELECTRONICS CO., LTD., Suwon-si (KR)

(21) Appl. No.: 19/670,750

(22) Filed: May 7, 2026

Related U.S. Application Data
(63) Continuation of application No. PCT/KR2024/016563, filed on Oct. 28, 2024.

(30) Foreign Application Priority Data
Nov. 7, 2023 (KR) 10-2023-0152864
Feb. 15, 2024 (KR) 10-2024-0021639

(51) Int. Cl. B25J 18/02; B25J 9/12; B25J 9/16; B25J 13/08; B25J 18/00

(52) U.S. Cl. CPC B25J 18/02; B25J 9/123; B25J 9/1612; B25J 13/089; B25J 18/005

(57) ABSTRACT

A robot includes: a main body; a robot arm provided on the main body; and a processor configured to control the robot arm to touch an external object located outside the main body, wherein the robot arm includes: a slide tag; a housing accommodating the slide tag; and a driver configured to move the slide tag to protrude outside of the housing and retract into the housing under control of the processor.

### CROSS-REFERENCE TO RELATED APPLICATIONS

This application is a continuation of International Application No. PCT/KR2024/016563, filed on October 28, 2024, which is based on and claims priority to Korean Patent Application No. 10-2023-0152864, filed on November 7, 2023, and Korean Patent Application No. 10-2024-0021639, filed on February 15, 2024, in the Korean Intellectual Property Office, the disclosures of which are incorporated by reference herein in their entireties.

### BACKGROUND

### 1. Field

The disclosure relates to a robot arm, a robot including the robot arm, and a control method therefor.

### 2. Description of Related Art

With the advancement of robotics technology, various types of robots equipped with unmanned systems are being developed and distributed. Various robots are being used, such as cooking robots that cook ordered food on behalf of humans, serving robots that serve food, and delivery robots that deliver items to customers. In order for such a robot to enter and exit a building or to move within the building by getting on/off an elevator, the robot should operate a door opening/closing device to open/close a door.

However, since the operating mechanism of the door opening/closing devices varies depending on the door installed in a building, technology is required that enables the robot to perform the door opening operation according to the operating mechanism of each door opening/closing device. For example, when the door opening/closing device is implemented as a push button, the robot is required to have a function of pressing the push button. When the door opening/closing device is implemented as a radio-frequency identification (RFID) reader or near field communication (NFC) method, the robot is required to have a function of transmitting identification (ID) information to the door opening/closing device.

### SUMMARY

According to an aspect of the disclosure, a robot includes: a main body; a robot arm provided on the main body; and a processor configured to control the robot arm to touch an external object located outside the main body, wherein the robot arm includes: a slide tag; a housing accommodating the slide tag; and a driver configured to move the slide tag to protrude outside of the housing and retract into the housing under control of the processor.

According to an aspect of the disclosure, a robot arm includes: a housing including a rail having a continuous slope; a slide tag configured to slide along the rail and including an identification chip; a linear motor; and a driving cylinder connected to the slide tag by a movable pin and configured to reciprocate linearly by a driving of the linear motor, wherein the movable pin is movably connected between an end portion of the driving cylinder and the slide tag such that the slide tag is driven in an inclined direction by a driving force of the driving cylinder.

According to an aspect of the disclosure, a control method for a robot including a robot arm, includes: identifying a location of an external object when the robot approaches the external object; and protruding, based on the identified location, a slide tag accommodated within the robot arm outward to touch the external object, wherein the robot arm includes: a housing including a rail having a predetermined curvature and accommodating the slide tag on the rail; and a driver configured to move the slide tag so that the slide tag slides along the rail and protrudes to outside of the housing.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for describing a configuration of a robot according to one or more embodiments of the present disclosure;

FIG. 2 is a diagram for describing an operation of the robot according to one or more embodiments of the present disclosure;

FIG. 3 is a block diagram illustrating the configuration of the robot according to one or more embodiments of the present disclosure;

FIGS. 4 and 5 are perspective views for describing a configuration of a robot arm according to one or more embodiments of the present disclosure;

FIG. 6 is a cross-sectional view for describing a configuration of a slide tag according to one or more embodiments of the present disclosure;

FIG. 7 is a diagram for describing an operation of a cap according to one or more embodiments of the present disclosure; and

FIG. 8 is a flowchart for describing a control method for a robot according to one or more embodiments of the present disclosure.

### DETAILED DESCRIPTION

Hereinafter, example embodiments of the present disclosure will be described in detail with reference to the accompanying drawings.

The various example embodiments of the present disclosure described herein and terms used herein are not intended to limit the technical features described in the present disclosure to specific embodiments, and should be understood to include various changes, equivalents, or substitutes of the embodiments.

Throughout the accompanying drawings, similar or related components will be denoted by similar reference numerals.

A singular form of a noun corresponding to an item may include one or more of the item, unless the relevant context clearly dictates otherwise.

In the present disclosure, each phrase such as “A or B,” “at least one of A and B,” “at least one of A or B,” “A, B, or C,” “at least one of A, B and C,” and “at least one of A, B, or C” may include any one of items listed together in the corresponding one of those phrases, or all possible combinations thereof.

A term ‘and/or’ includes a combination of a plurality of related described components or any one of the plurality of related described components.

Terms such as “first,” “second,” “1^{st},” or “2^{nd}” may simply be used to distinguish a component from another component, and do not limit the components in other respects (e.g., importance or order).

When one (e.g., first) component is “coupled,” or “connected,” to another (e.g., second) component with or without the terms “functionally” or “communicatively,” it means that the one component may be connected to another component directly (e.g., in a wired manner), in a wireless manner, or through a third component.

It will be understood that terms ‘include’ or ‘have’ specify the presence of features, numerals, steps, operations, components, parts mentioned in the present disclosure, or a combination thereof, but do not preclude the presence or addition of one or more other features, numerals, steps, operations, components, parts, or a combination thereof.

When a component is said to be “connected,” “coupled,” “supported,” or “in contact” with another component, this includes not only cases where the components are directly connected, coupled, supported, or in contact, but also cases where they are indirectly connected, coupled, supported, or in contact through a third component.

When a component is “on” another component, this includes not only cases where a component is in contact with another component, but also cases where there is another component between the two components.

Hereinafter, an embodiment of the disclosure will be described in detail with reference to the accompanying drawings.

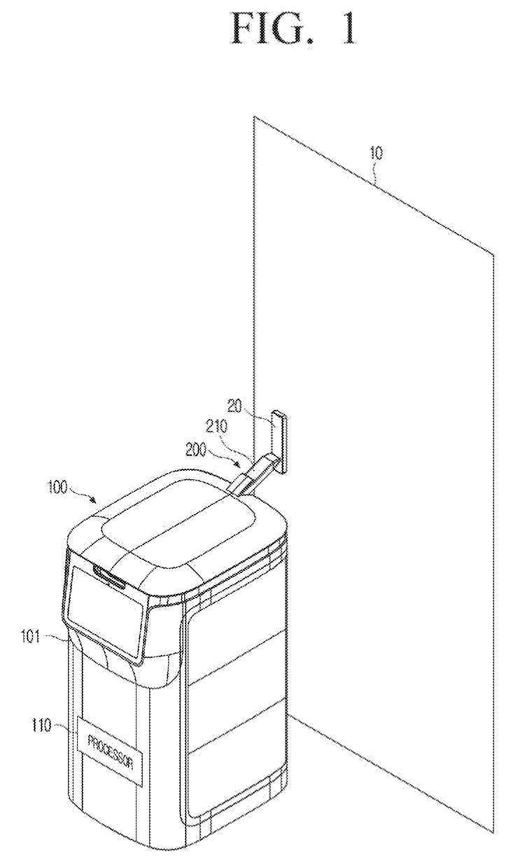

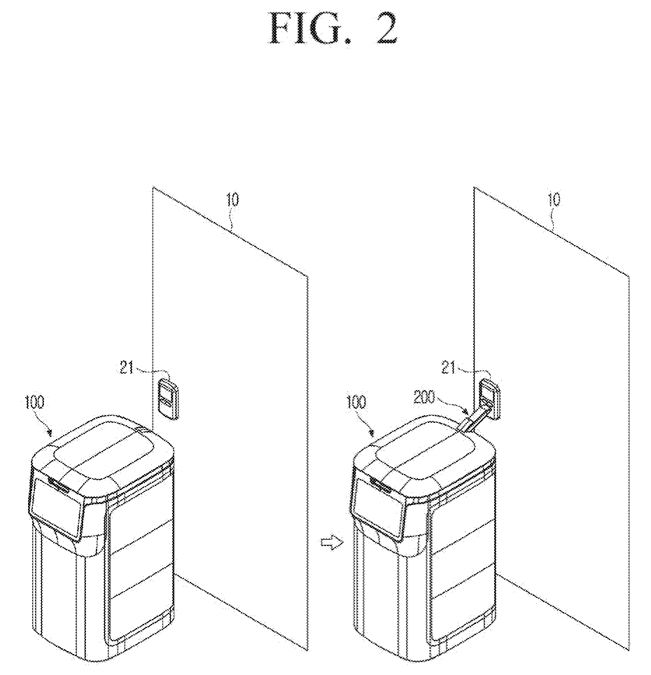

FIG. 1 is a diagram illustrating a configuration of a robot according to one or more embodiments of the present disclosure, and FIG. 2 is a diagram illustrating an operation of the robot according to one or more embodiments of the present disclosure.

A robot may be a device capable of traveling without being directly operated by a person. The robot 100 may be referred to by various terms, such as an autonomous mobile robot (AMR), an automated guided vehicle (AGV), or an unmanned ground vehicle (UGV), but is referred to as a robot 100 herein. Depending on a method of use or an intended purpose of the robot 100, the robot 100 may be implemented as a variety of robots capable of traveling through space and performing necessary tasks, such as a cleaning robot, a serving robot, a mobile projector, an industrial robot, a guide robot, or a delivery robot.

In this case, in order for the robot 100 to travel through space and perform necessary tasks, the robot 100 should pass through a door 10 disposed between spaces. For example, in order for the robot 100 to enter a building, the robot 100 should pass through the door 10 disposed at an entrance of the building. Even after the robot 100 enters the building, the robot 100 should open the door 10 installed in each workroom or office to enter a workroom or office.

In buildings where door opening/closing devices are operated under control of a central server, when the robot 100 transmits a signal to open/close the door 10 or elevator floor information to the central server, the corresponding door opening/closing device is operated under the control of the central server, and the robot 100 may enter and exit the building or move within the building through the opened door 10.

However, in buildings where the door opening/closing devices for opening/closing the doors 10 are operated by individual control methods, the robot 100 should directly open/close the door 10 using physical or electrical means, depending on the operating method of each door opening/closing device. For example, when the door opening/closing device is implemented as a physical push button, the robot 100 may perform an operation of pressing the push button to open the door 10. When the door opening/closing device is implemented as an electrical radio frequency identification reader (RFIC reader) or near field communication (NFC), the robot 100 may touch an RFID tag or ID card equipped with an identification chip to the door opening/closing device to open the door 10.

Related art robots may have difficulty opening/closing doors using physical or electrical means, depending on the operating method of each door opening/closing device. For example, the robot equipped with the ability to operate the push button to open/close a door has had difficulty operating the door opening/closing device based on the RFID reader or near field communication (NFC) method. Similarly, the robot equipped with the ability to operate the door opening/closing device based on the RFID reader method has had difficulty operating the push button.

However, since the method for operating the door opening/closing device differs from building to building, and the method for operating the door opening/closing device differs for each door even within the same building, when the robot may not operate both a door opening device based on a physical method such as the push button and a door opening device based on an electrical method such as the RFID reader or NFC, the robot will not be able to move freely within the building. In particular, since the door opening/closing device based on the RFID reader or the NFC method has a small contact surface area for touching an RFID tag or an identification card, the door opening/closing device may be difficult for the robot to accurately adjust the location of the contact surface to touch the RFID tag or the identification card.

According to one or more embodiments of the present disclosure, the robot 100 may open each door 10 by operating the door opening/closing device implemented using the physical method or electrical method.

Referring to FIG. 1, the robot 100 includes a main body 101, a robot arm 200 mounted on the main body 101, and a processor 110 that controls the robot arm 200 to touch an external object 20 located outside the main body 101. The external object 20 represents an object for the robot 100 to perform an operation, such as a touch or push, using the robot arm 200. For example, the external object 20 may include a push button, a bell, an RFID reader, an NFC, various sensors, etc.

The external object 20 may also include the door opening/closing device that opens/closes the door 10. The door opening/closing device is a device disposed on one side of the door 10 or a wall, and is operated by an external signal or physical pressurization to open/close the door 10. In FIG. 1, the external object 20 represents the door opening/closing device implemented as the push button, and in FIG. 2, the external object represents the door opening/closing device implemented as an RFID reader 21.

However, the external object 20 is not limited thereto, and any object that may be manipulated and operated by the robot arm 200 mounted on the robot 100 may be used, depending on the purpose and function of the robot arm 200.

The robot arm 200 includes a slide tag 210, a housing that accommodates the slide tag 210, and a driver that moves the slide tag 210 so that the slide tag 210 protrudes to the outside of the housing under the control of a processor 110. The detailed configuration and operation of the robot arm 200 will be described again in the following section.

In FIG. 2, the left drawing illustrates the state of the robot 100 before the robot 100 operates the robot arm 200, and the right drawing illustrates the state of the robot 100 after the robot 100 operates the robot arm 200.

Referring to FIG. 2, the robot arm 200 may be accommodated inside the robot 100. When the robot 100 approaches the external object 20, the processor 110 may identify the location of the external object 20 and operate the robot arm 200. For example, when the external object is implemented as the RFID reader 21, as illustrated in FIG. 2, and the robot 100 approaches the door 10 equipped with the RFID reader 21, the processor 110 may control the driver to protrude the slide tag 210 to the outside of the robot 100. In this case, an identification chip capable of transmitting identification information to the RFID reader 21 may be disposed at an end portion of the slide tag 210.

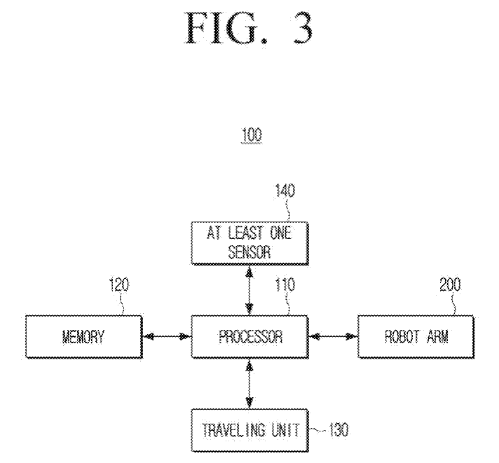

FIG. 3 is a block diagram illustrating the configuration of the robot according to one or more embodiments of the present disclosure.

Referring to FIG. 3, the robot 100 may include a processor 110, memory 120, a traveling unit 130, at least one sensor 140, and a robot arm 200.

The processor 110 is a component connected to each component of the robot 100 and configured to control the overall operation of the robot 100. The processor 110 may be implemented by a digital signal processor (DSP), a microprocessor, a graphics processing unit (GPU), an artificial intelligence (AI) processor, or a neural processing unit (NPU). However, the processor 110 is not limited thereto, and may include one or more of a central processing unit (CPU), a micro controller unit (MCU), a micro processing unit (MPU), a controller, an application processor (AP), a communication processor (CP), and an ARM processor, or may be defined by these terms. In addition, the processor 110 may be implemented by a system-on-chip (SoC) or a large scale integration (LSI) in which a processing algorithm is embedded, or may be implemented in the form of an application specific integrated circuit (ASIC) and a field programmable gate array (FPGA).

The memory 120 may store at least one instruction, data, program, etc., necessary for the operation of the robot 100. As an example, the memory 120 may store at least one of height information of the external object 20, map information of a building, or location information of a customer. The memory 120 may be implemented as at least one of, for example, a volatile memory (for example, a dynamic random access memory (DRAM), a static RAM (SRAM), a synchronous dynamic RAM (SDRAM), or the like), a non-volatile memory (for example, a one time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash, a NOR flash, or the like), a hard drive, or a solid state drive (SSD)).

The memory 120 may be implemented as a single memory that stores data generated in various operations according to the present disclosure, but is not limited thereto, and the memory 120 may be implemented to include a plurality of memories, each of which stores different types of data or stores data generated in different stages.

The traveling unit 130 is a component for moving the robot 100. The traveling unit 130 may include one or more wheels, axles, motors, etc. Depending on the operation of the traveling unit 130, the robot 100 is capable of moving forward, moving backward, rotating, changing direction, etc. The processor 110 may control the traveling unit 130 so that the robot 100 may drive according to a user’s settings or a predetermined traveling path. For example, when the robot 100 is a delivery robot that delivers items to customers, the processor 110 may set a traveling path based on a customer’s location information stored in the memory 120 and control the traveling unit 130 so that the robot 100 may drive to the customer’s location according to the predetermined traveling path.

At least one sensor 140 is a component for sensing various information related to the operation of the robot 100. At least one sensor 140 may include at least one of a distance sensor, a gyro sensor, an acceleration sensor, a gravity sensor, a geomagnetic sensor, an image sensor, or a 3D camera. For example, the distance sensor is configured to sense the distance to the external object 20. The processor 110 may identify the distance to the external object 20 based on the sensing value of the distance sensor. The distance sensor may include at least one of an ultrasonic sensor, an infrared sensor, a laser sensor, an optical distance sensor, a radar (RADAR) sensor, a LIDAR sensor, a photodiode sensor, or a time-of-flight (TOF) sensor.

For example, the ultrasonic sensor emits ultrasonic waves toward a bottom surface on which the robot 100 is traveling and receives the ultrasonic waves that are reflected from the floor and returned to the ultrasonic sensor. The processor 110 may determine a material of a floor by analyzing the amount of reflected ultrasonic waves, reflection intensity, spectrum, etc. When an ultrasonic sensor emits ultrasonic waves toward the external object 20, the processor 110 may calculate the distance to the external object 20 by using a time difference between the output and reception times of the ultrasonic waves.

The LIDAR sensor may rotate 360° around the space where the robot 100 is located and emit laser light. When the laser light is reflected from an object around the robot 100 and received by the LIDAR sensor, the LIDAR sensor may measure a distance to an object based on the reception time. This distance measurement may be performed from various angles and directions to generate data information on the surrounding environment.

The processor 110 may identify various types of information, such as location information about the space where the robot 100 is located, information about objects existing in the space, and information about the bottom surface, based on the sensing value of at least one sensor 140. The processor 110 may control the operation of the robot 100 based on the identified various types of information. For example, the processor 110 may identify the distance to the external object 20 based on the sensing value of at least one sensor 140 and control the driver to protrude the slide tag 210 to the outside of the housing by a length corresponding to at least one of the identified distance or height information.

When the processor 110 identifies that there is a foreign substance or obstacle on the set traveling path based on the sensing value of at least one sensor 140, the processor 110 may control the traveling unit 130 to change the traveling path of the robot 100. When the processor 110 identifies that there is the door 10 on the set traveling path, the processor 110 may also control at least one sensor 140 to sense the location information of the door opening/closing device.

The robot arm 200 is configured to touch the external object 20 located outside the main body 101 of the robot 100. The processor 110 may control the robot arm 200 to operate the door opening/closing device. The detailed configuration and operation of the robot arm 200 will be described again with reference to the drawings below.

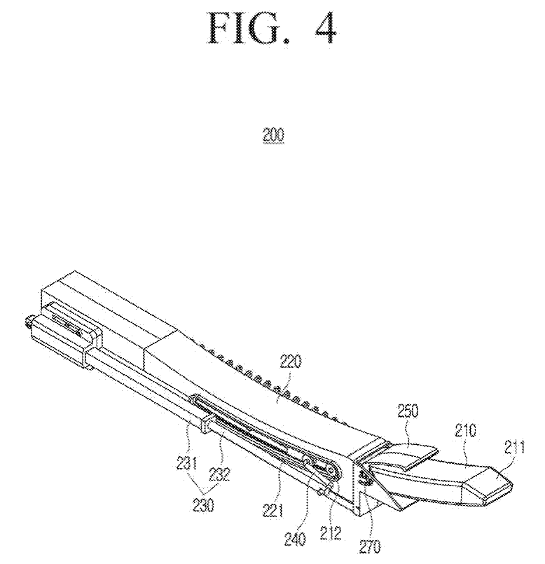

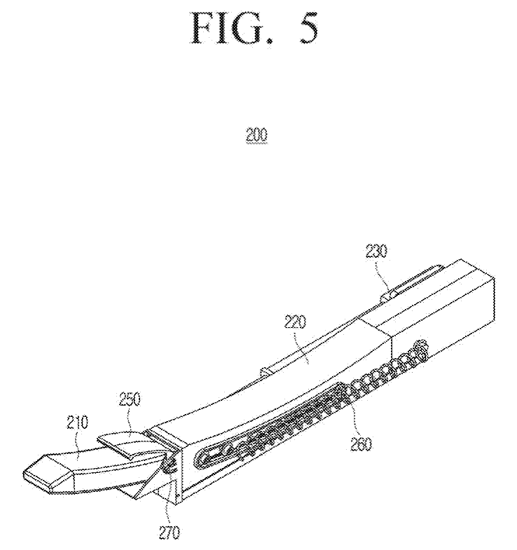

FIGS. 4 and 5 are perspective views for describing a configuration of a robot arm according to one or more embodiments.

Referring to FIGS. 4 and 5, the robot arm 200 may include a slide tag 210, a housing 220, a driver 230, a movable pin 240, a cap 250, a fixed spring 260, and a torsion spring 270.

The slide tag 210 is a component for touching or pushing the external object 20. The slide tag 210 may be expressed by various names such as a link, a finger, a frame, a shaft, a robot hand, and a grip device depending on the function and purpose of the robot arm. However, for convenience of description, the following description will be based on the slide tag 210. The slide tag 210 may be disposed on a rail 221 and may slide along the rail 221. The slide tag 210 may be located inside the housing 220 before the robot 100 operates the robot arm 200, and may protrude to the outside of the housing 220 when the robot 100 operates the robot arm 200.

A first buffer member 211 may be disposed on an end portion of the slide tag 210 to buffer impact upon contact with the external object 20. The slide tag 210 may be used in various ways depending on the purpose and function of the robot arm 200 mounted on the robot 100. For example, when the external object 20 is implemented as an electrical structure such as a radio-frequency identification (RFID) reader or near field communication (NFC), the robot 100 may use the robot arm 200 to touch the external object 20. However, when the external object 20 is implemented as a physical structure such as a push button, the robot 100 may use the robot arm 200 to push the external object 20. In this case, when excessive force (overstroke) is continuously applied to the slide tag 210, the robot arm 200 may malfunction.

The first buffer member 211 may be composed of a material capable of buffering impact applied to the slide tag 210. For example, the first buffer member 211 may be composed of at least one of rubber, a spring, foam plastic, soft EPS, or EVA (synthetic rubber).

In addition, one side of the slide tag 210 may further be provided with an identification chip for transmitting identification information to the external object 20. When the external object 20 is implemented as the door opening/closing device such as an RFID reader or NFC, the robot 100 may open the door 10 by touching the slide tag 210 on which the identification chip is located to the contact surface of the RFID reader or NFC.

One side of the slide tag 210 may be provided with a wheel 212. The wheel 212 may be disposed on the rail 221 to reduce a friction force between the slide tag 210 and the rail 221 when the slide tag 210 slides along the rail 221.

The housing 220 may include the rail 221 having a continuous slope. For example, the housing 220 may include the rail 221 that is curved to have a predetermined curvature. However, embodiments of the present disclosure are not limited thereto, and the rail 221 may be a straight rail having a constant slope upward or downward within the housing 220. However, in the case of a straight rail having a continuous slope upward or downward, the installation space occupied within the housing 220 may be larger than that of a rail 221 that is curved to have a predetermined curvature. On the other hand, when the rail 221 that is curved to have a predetermined curvature is disposed within the housing 220, there is an advantage in that the robot arm 200 may be installed in a smaller space than that of a structure such as a straight rail or a manipulator.

When the robot 100 operates the robot arm 200 to touch the external object 20, the angle of the slide tag 210 protruding from the main body 101 of the robot 100 may be determined by at least one of the installation angle of the housing 220 disposed inside the main body 101 or the inclination angle of the rail 221. The information about the installation angle of the housing 220 and the inclination angle of the rail 221 may be stored in the memory 120. The processor 110 may adjust the protruding length of the slide tag 210 based on the information about the installation angle of the housing 220 and the inclination angle of the rail 221 stored in the memory 120.

For example, when the heights of external objects 20 are disposed differently from each other and the housing 220 disposed inside the robot 100 is disposed at an angle parallel to the main body 101 or the ground, the processor 110 may determine the protrusion angle of the slide tag 210 based on the inclination angle of the rail 221. However, when the housing 220 is disposed inside the main body 101 to have a continuous slope with the main body 101 or the ground, the processor 110 may determine the protrusion angle of the slide tag 210 based on the sum of the installation angle of the housing 220 and the inclination angle of the rail 221.

For convenience of description, the following description will be based on the case where the housing 220 disposed within the robot 100 is disposed at an angle parallel to the main body 101 or the ground.

When the height of the external object 20 installed within a building is disposed at a predetermined height, and the robot arm 200 is implemented at a height corresponding to the height of the external object 20, the processor 110 may protrude the slide tag 210 by a predetermined length according to the inclination angle of the predetermined rail 221. For example, when the height of the external object 20 and the robot arm 200 are implemented at the same height, and the rail 221 is disposed at an angle parallel to the main body 101 or the ground, the processor 110 may protrude the slide tag 210 by a predetermined length to touch or push the external object 20.

When the height of the external object 20 installed inside the building is disposed at a predetermined height that is relatively high compared to the robot arm 200, the rail 221 may be implemented in a shape that is curved upwards to have a predetermined curvature. Similarly, when the height of the external object 20 is disposed at a predetermined height that is relatively low compared to the robot arm 200, the rail 221 may be implemented in a shape that is curved downwards to have a predetermined curvature. In this case, when the location of the external object 20 is identified, the processor 110 may touch or push the external object 20 by protruding the slide tag 210 to a predetermined length. In this way, when the height of the external object 20 is disposed at a predetermined height, the processor 110 may identify the distance to the external object 20 and protrude the slide tag 210 by the identified distance to touch or push the external object 20.

However, when the external objects 20 are disposed at different heights, the processor 110 may adjust the protrusion length of the slide tag 210 based on the distance from the external objects 20 and the height of the external objects 20.

For example, when the external objects 20 have heights that are relatively greater than that of the robot arm 200 and are disposed at mutually different heights, the rail 221 may be implemented in a shape that is curved upward with a predetermined curvature, or may be disposed as a straight rail with a continuous slope upward. In this case, when the location of the external object 20 is identified, the processor 110 may adjust the protrusion length of the slide tag 210 based on the height of the external object 20. Specifically, the processor 110 calculates the protrusion length of the slide tag 210 that may reach the height of the external object 20 based on the predetermined inclination angle of the rail 221, and moves the location of the robot 100 so that the robot 100 may touch or push the external object 20 through the protrusion length of the slide tag 210. When the robot 100 is located at an appropriate distance, the processor 110 may protrude the slide tag 210 by the calculated protrusion length to touch or push the external object 20.

When the external objects 20 have heights that are relatively lower than that of the robot arm 200 and are disposed at mutually different heights, the rail 221 may be implemented in a shape that is curved downward to have a predetermined curvature, or may be disposed as a straight rail with a continuous slope downward. In this case, when the location of the external object 20 is identified, the processor 110 may adjust the protrusion length of the slide tag 210 based on the height of the external object 20. Specifically, the processor 110 calculates the protrusion length of the slide tag 210 that may reach the height of the external object 20 based on the predetermined inclination angle of the rail 221, and moves the location of the robot 100 so that the robot 100 may touch or push the external object 20 through the protrusion length of the slide tag 210. When the robot 100 is located at an appropriate distance, the processor 110 may protrude the slide tag 210 by the calculated protrusion length to touch or push the external object 20.

The driver 230 may move the slide tag 210 so that the slide tag 210 protrudes to the outside of the housing 220 under the control of the processor 110. For example, the driver 230 may include a linear motor 231 and a driving cylinder 232.

While a typical motor generates a rotational motion, the linear motor 231 may generate a linear propulsive force. When current flows through a coil in the motor, a magnetic force is generated. When the generated magnetic force has the same polarity as the permanent magnet, a repulsive force is generated, and when the generated magnetic force and the permanent magnet have different polarities, an attractive force is generated. The linear motor 231 may move an object in a linear direction by utilizing this principle.

As illustrated in FIG. 4, an object moved by a linear motor 231 may be the driving cylinder 232. The driving cylinder 232 may reciprocate in a straight line by driving the linear motor 231. Specifically, when the processor 110 operates the linear motor 231, the driving cylinder 232 may move in a straight line and protrude the slide tag 210 to the outside of the housing 220. In this case, as the slide tag 210 protrudes, the cap 250 covering the opening of the housing 220 may be pushed and opened.

The processor 110 may control the linear motor 231 to touch or push the slide tag 210 to the external object 20. When the touch or push operation of the external object 20 by the slide tag 210 is completed, the processor 110 may control the linear motor 231 to move the slide tag 210 in the opposite direction to retract the slide tag 210 into the housing 220. In this case, when the slide tag 210 is retracted into the housing 220, the cap 250 may close and cover the opening of the housing 220.

Referring to FIG. 4, the robot arm 200 may include a movable pin 240 that connects the driving cylinder 232 and the slide tag 210. The movable pin 240 may be movably connected between the end portion of the driving cylinder 232 and the slide tag 210 so that the slide tag 210 may be driven in an inclined direction by the driving force of the driving cylinder 232. Specifically, when the driving cylinder 232 moves in a straight direction, the slide tag 210 slides along the rail 221 in an inclined direction, so the moving angles of the driving cylinder 232 and the slide tag 210 change.

The movable pin 240 may move in response to the difference in the moving angle between the driving cylinder 232 and the slide tag 210 and transmit the driving force of the driving cylinder 232 to the slide tag 210.

The cap 250 is hinged to the opening portion of the housing 220 through which the slide tag 210 protrudes, thereby opening the opening by the protrusion of the slide tag 210 and covering the opening by the retraction of the slide tag 210 into the housing. Specifically, the cap 250 covers the opening of the housing 220 when the slide tag 210 is located inside the housing 220, and is pushed by the first buffer member 211 disposed at an end portion of the slide tag 210 when the slide tag 210 protrudes, thereby opening the opening of the housing 220.

In this case, a protrusion may be formed on a lower rear portion of the cap 250. In addition, a catch member may be formed on one surface of the slide tag 210. The protrusion and the catch member may be implemented at corresponding positions. Specifically, after the cap 250 is opened by being pushed by the first buffer member 211, the protrusion catches the catch member while the slide tag 210 protrudes, thereby maintaining the open state of the cap 250.

FIG. 5 is a perspective view of the robot arm 200 viewed from the opposite direction of FIG. 4.

Referring to FIG. 5, the robot arm 200 may further include a fixed spring 260 for elastically connecting the housing 220 and the slide tag 210. When the slide tag 210 is located inside the housing 220 or protrudes to the outside of the housing 220, the slide tag 210 may swing according to the movement of the robot 100. The fixed spring 260 may elastically support the slide tag 210 so that the slide tag 210 does not swing up and down or left and right when the slide tag 210 is located inside the housing 220 or protrudes to the outside of the housing 220.

Referring to FIGS. 4 and 5, the robot arm 200 may further include a torsion spring 270 disposed on one side of the housing 220. The torsion spring 270 is compressed by the opening of the cap 250, and when the slide tag 210 is retracted inside of the housing 220, the cap 250 may provide a compressive force to cover the opening. The detailed configuration and operation of the torsion spring 270 will be described again in the following section.

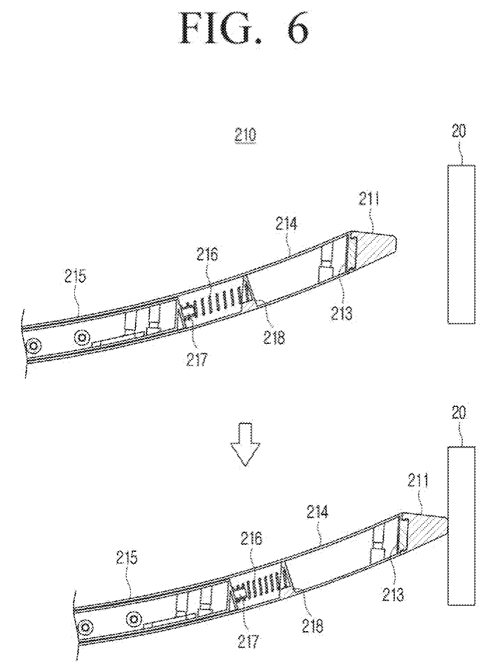

FIG. 6 is a cross-sectional view illustrating the configuration of a slide tag according to one or more embodiments. In FIG. 6, the upper drawing is a drawing illustrating a state before the slide tag 210 touches the external object 20, and the lower drawing is a drawing illustrating a state when the slide tag 210 touches the external object 20.

Referring to FIG. 6, the slide tag 210 may include a first slide member 214, a second slide member 215, and a second buffer member 216. The identification chip 213 may be disposed on the first slide member 214. The identification chip 213 may be disposed between the first slide member 214 and the first buffer member 211. Additionally, the identification chip 213 may include a memory for storing a unique code or identification information.

For example, when the external object 20 is implemented as the RFID reader, the identification chip 213 in the slide tag 210 may be implemented in the form of the RFID tag or identification card (ID card). In this case, the RFID tag or identification card (ID card) may further include an antenna for receiving a signal from the RFID reader and transmitting information stored in the identification chip 213. The antenna is implemented in a thin film or coil form, and thus may transmit the information stored in the identification chip 213 to the RFID reader or receive signals from the RFID reader.

When the identification chip 213 is not implemented in the form of the RFID tag or identification card, the antenna may be located inside the first buffer member 211 and connected to the identification chip 213. For example, when the slide tag 210 touches the RFID reader, the information stored in the identification chip 213 may be transmitted to the RFID reader or a signal may be received from the RFID reader via the antenna located inside the first buffer member 211.

Meanwhile, the RFID reader may transmit and receive signals to and from the identification chip via the antenna of the RFID tag or the antenna connected to the identification chip. The antenna embedded in the RFID tag or the antenna connected to the identification chip receives radio waves from the RFID reader. The identification chip is activated by the received radio waves, converts the information stored in its memory into a signal, and transmits the generated signal through the antenna. The RFID reader may receive a signal transmitted from an antenna connected to the identification chip and identify the unique code or information stored in the identification chip.

The second slide member 215 may be connected to the driver 230. As described above, the second slide member 215 may be movably connected to the driving cylinder 232 of the driver 230 via the movable pin 240. The first slide member 214 and the second slide member 215 may be fitted together. In addition, the second buffer member 216 may be arranged between the first slide member 214 and the second slide member 215.

The second buffer member 216 may be made of a flexible material to buffer the impact applied to the slide tag 210 from the external object 20 when the slide tag 210 touches the external object 20. When the slide tag 210 touches the external object 20, the first slide member 214 moves backward, and the impact force may be absorbed by the second buffer member 216. After the force applied to the slide tag 210 from the external object 20 is removed, the slide tag 210 may restore a gap between the first slide member 214 and the second slide member 215 by using the energy accumulated by the deformation of the second buffer member 216.

The second buffer member 216 may be composed of at least one of rubber, a spring, foam plastic, soft EPS, or EVA (synthetic rubber). For example, when the second buffer member 216 is implemented as a spring, the end portion of the second slide member 215 may further include a first fixing member 217 for fixing the spring. Additionally, a support member 218 for supporting the elasticity of the spring may be further included on one side of the first slide member 214.

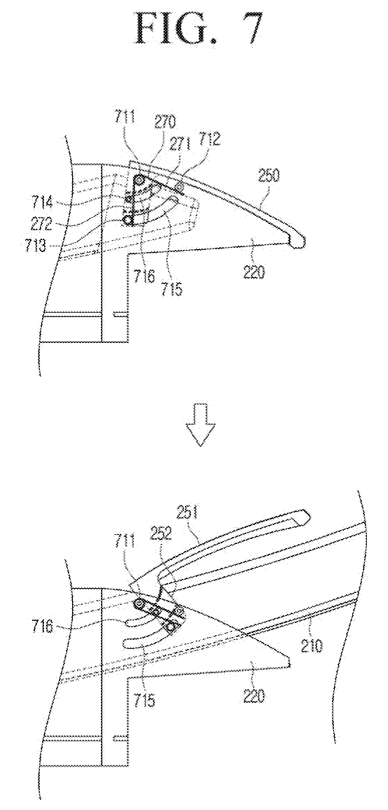

FIG. 7 is a diagram for describing an operation of a cap according to one or more embodiments of the present disclosure. In FIG. 7, the left drawing illustrates a state in which the cap 250 is closed, and the right drawing illustrates a state in which the cap 250 is opened by the protrusion of the slide tag 210.

Referring to FIG. 7, the torsion spring 270 may be disposed on one side of the housing 220. For example, the torsion spring 270 may be disposed in an opening portion of the housing 220. FIG. 7 illustrates a state in which the torsion spring 270 is disposed outside the opening of the housing 220. However, embodiments of the present disclosure are not limited thereto, and the torsion spring 270 may have any shape and location that may provide a compressive force for the cap 250 to cover the opening when the slide tag 210 is retracted inside the housing 220. For example, the torsion spring 270 may be disposed between the housing 220 and the cap 250 on the inside of the opening of the housing 220.

As illustrated in the left drawing of FIG. 7, a central axis 711 for fixing the center of the torsion spring 270 may be provided on one side of the housing 220. A second fixing member 712 for fixing a fixed-side arm 271 of the torsion spring 270 may be provided on the other side of the housing 220.

In this case, the cap 250 may include a cover member 251 for covering the opening of the housing 220 and a connecting member 252 connected to one side of the housing 200, and may be implemented in a shape in which the cover member 251 and the connecting member 252 are combined to have a predetermined angle. For example, the cap 250 may be configured in a “┐” shape. In addition, a first coupling protrusion 713 and a second coupling protrusion 714 for coupling with the housing 220 may be provided on one side of the connecting member 252 of the cap 250. A first coupling groove 715 and a second coupling groove 716 may be formed at locations corresponding to the first coupling protrusion 713 and the second coupling protrusion 714 in the housing 220 into which the first coupling protrusion 713 and the second coupling protrusion 714 are respectively fitted. However, embodiments of the present disclosure are not limited thereto, and the coupling protrusion and the coupling groove may be implemented as a pair, or may be implemented as three or more pairs.

The first coupling groove 715 and the second coupling groove 716 may be implemented in a curved shape with a predetermined curvature so that the first coupling protrusion 713 and the second coupling protrusion 714 may be movably coupled along the movement path of the connecting member 252 when the cap 250 is opened. A movable-side arm 272 of the torsion spring 270 may be supported by at least one of the first coupling protrusion 713 or the second coupling protrusion 714. For example, FIG. 7 illustrates a state in which the movable-side arm 272 of the torsion spring 270 is supported by the first coupling protrusion 713. Since the movable-side arm 272 of the torsion spring 270 is supported by the first coupling protrusion 713, the gap between the fixed-side arm 271 and the movable-side arm 272 of the torsion spring 270 may be narrowed and compressed when the cap 250 is opened. In this case, the second coupling protrusion 714 does not support the movable-side arm 272 of the torsion spring 270, but may be movably coupled to the housing 220 so that the cap 250 may move stably without shaking when the cap 250 is opened.

The torsion spring 270 is compressed when the cap 250 is opened, and when the slide tag 210 is retracted inside of the housing 220, the compressive force generated when the cap 250 is opened may be used to provide a restoring force for the cap 250 to cover the opening of the housing 220.

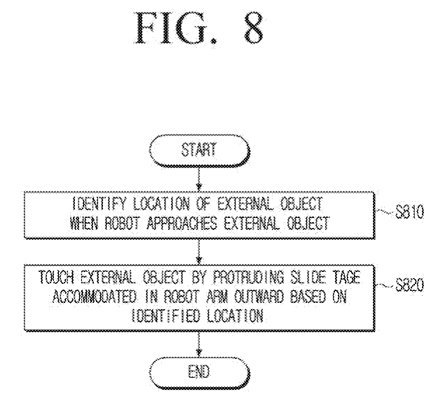

FIG. 8 is a flowchart for describing a control method for a robot according to one or more embodiments of the present disclosure.

Referring to FIG. 8, when a robot approaches an external object, the robot identifies the location of the external object (S810). When the location information of the external object is stored in the robot, the robot may identify the location of the external object based on the stored location information. For example, when the robot moves within a building, the robot may store a building map indicating a location of a door. Alternatively, the robot may sense the location of the external object using at least one sensor. In this case, at least one sensor may include at least one of a distance sensor, a gyro sensor, an acceleration sensor, a gravity sensor, a geomagnetic sensor, an image sensor, or a 3D camera.

Based on the identified location, the robot protrudes the slide tag accommodated within the robot arm outward to touch the external object (S820). In this case, the robot arm may include the housing that accommodates the slide tag and the driver that moves the slide tag so that the slide tag protrudes to the outside of the housing. The housing may include a rail curved to have a predetermined curvature and may accommodate the slide tag on the rail. The robot may control the driver to cause the slide tag to slide along the rail and protrude to the outside of the housing.

Once the location of the external object is identified, the robot may determine the distance to the external object based on the location information or the sensing information stored in memory. The robot may then adjust the protrusion length of the slide tag accommodated within the robot arm based on the distance and height of the identified external object to touch the external object.

Since the rail accommodating the slide tag is disposed to have a predetermined curvature, the longer the protrusion length of the slide tag, the greater the height at which the slide tag may touch. For example, when the height of the external object is the same as the height of the robot arm, the robot may move to a position close to the external object and then protrude the slide tag by a short distance to touch the external object. When the height of the external object is relatively higher than the height of the robot arm, the robot may move away from the external object and then protrude the slide tag by a long distance to adjust the distance and height.

When the robot has completed touching the external object with the slide tag, the robot may control the driver to move the slide tag into the housing. In this case, when the slide tag is retracted inside the housing, the cap may cover the opening of the housing.

Therefore, the robot arm according to one or more embodiments of the present disclosure, the robot including the robot arm, and the control method therefor may operate both physical door opening/closing devices, such as a push button, and electrical door opening/closing devices, such as an RFID reader or NFC, thereby enabling free movement within various buildings.

Furthermore, the robot arm according to one or more embodiments of the present disclosure, the robot including the robot arm, and the control method therefor have the advantage of enabling installation of the robot arm in narrow spaces, compared to the manipulator, while allowing adjustment of the touch height by the robot arm. Furthermore, the robot arm according to one or more embodiments of the present disclosure may simplify its structure by adopting a single-axis method, rather than a multi-axis method like the manipulator.

According to an embodiment of the disclosure, one or more embodiments described above may be implemented by software including instructions stored in a machine-readable storage medium (for example, a computer-readable storage medium). A machine is a device capable of calling a stored instruction from a storage medium and operating according to the called instruction, and may include the robot according to the disclosed embodiments. In the case in which a command is executed by the processor, the processor may directly perform a function corresponding to the command or perform the function by using other components under control of the processor. The command may include codes created or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

In addition, according to an embodiment of the disclosure, the above-described methods according to the diverse embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore^{TM}). In case of the online distribution, at least a portion of the computer program product may be at least temporarily stored in a storage medium such as a memory of a server of a manufacturer, a server of an application store, or a relay server or be temporarily generated.

In addition, each of components (for example, modules or programs) according to one or more embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Although embodiments of the disclosure have been illustrated and described hereinabove, the disclosure is not limited to the abovementioned specific embodiments, but may be variously modified by those skilled in the art to which the disclosure pertains without departing from the gist of the disclosure as disclosed in the accompanying claims. These modifications should also be understood to fall within the scope and spirit of the disclosure.

What is claimed is:

1. A robot comprising: a main body; a robot arm provided on the main body; and a processor configured to control the robot arm to touch an external object located outside the main body, wherein the robot arm comprises: a slide tag; a housing accommodating the slide tag; and a driver configured to move the slide tag to protrude outside of the housing and retract into the housing under control of the processor.

2. The robot as claimed in claim 1, wherein the housing comprises a rail having a predetermined curvature, and
wherein the slide tag is provided on the rail and is configured to move by sliding along the rail.

3. The robot as claimed in claim 2, further comprising: a traveling unit comprising a motor and configured to move the robot; at least one sensor; a memory configured to store height information of the external object; and at least one processor configured to: control the traveling unit to move the robot and identify a distance to the external object based on a sensing value of the at least one sensor, and control the driver to move the slide tag to protrude outside of the housing by a length corresponding to at least one of the distance or the height information.

4. The robot as claimed in claim 1, wherein the robot arm further comprises a fixed spring elastically connecting the housing and the slide tag.

5. The robot as claimed in claim 1, wherein the driver comprises: a linear motor; and a driving cylinder configured to reciprocate linearly by driving of the linear motor, and wherein an end portion of the driving cylinder and the slide tag are connected by a movable pin.

6. The robot as claimed in claim 5, wherein the movable pin is movably connected between an end portion of the driving cylinder and the slide tag such that the slide tag is driven in an inclined direction by a driving force of the driving cylinder.

7. The robot as claimed in claim 1, wherein the robot arm further comprises a first buffer member at an end portion of the slide tag and configured to buffer impact upon contact with the external object.

8. The robot as claimed in claim 1, wherein the robot arm further comprises an identification chip at an end portion of the slide tag to transmit identification information upon contact with the external object.

9. The robot as claimed in claim 8, wherein the slide tag comprises: a first slide member on which the identification chip is provided; a second slide member connected to the driver; and a second buffer member between the first slide member and the second slide member.

10. The robot as claimed in claim 1, wherein the robot arm further comprises a cap hinged to an opening portion of the housing through which the slide tag protrudes so that the opening portion is open by protrusion of the slide tag and the opening portion is covered by a retraction of the slide tag.

11. The robot as claimed in claim 10, wherein the robot arm further comprises: a protrusion on a rear lower portion of the cap; and a catch member on a surface of the slide tag so that the slide tag contacts the protrusion while protruding to maintain the cap in an open state.

12. The robot as claimed in claim 10, wherein the robot arm further comprises a torsion spring on a side of the housing, and wherein the torsion spring is compressed by opening of the cap, and is configured to, in a state that the slide tag is retracted into the housing, provide a compressive force for the cap to cover the opening portion.

13. A robot arm comprising: a housing comprising a rail having a continuous slope; a slide tag configured to slide along the rail and comprising an identification chip; a linear motor; and a driving cylinder connected to the slide tag by a movable pin and configured to reciprocate linearly by a driving of the linear motor, wherein the movable pin is movably connected between an end portion of the driving cylinder and the slide tag such that the slide tag is driven in an inclined direction by a driving force of the driving cylinder.

14. The robot arm as claimed in claim 13, wherein the slide tag comprises: a first slide member on which the identification chip is provided; a second slide member connected to the driving cylinder; and a buffer member between the first slide member and the second slide member.

15. A control method for a robot comprising a robot arm, the control method comprising: identifying a location of an external object when the robot approaches the external object; and protruding, based on the identified location, a slide tag accommodated within the robot arm outward to touch the external object, wherein the robot arm comprises: a housing comprising a rail having a predetermined curvature and accommodating the slide tag on the rail; and a driver configured to move the slide tag so that the slide tag slides along the rail and protrudes to outside of the housing.
